(19) United States
(12) Patent Application Publication
(10) Pub. No.: US 2009/0164600 A1
(43) Pub. Date: Jun. 25, 2009

(54) SYSTEM AND METHOD FOR PLACE-SHIFTING MEDIA ITEMS

(75) Inventors: Alfredo C. Issa, Apex, NC (US); Juan A. Pons, Pittsboro, NC (US); Richard J. Walsh, Raleigh, NC (US)

Correspondence Address: WITHROW & TERRANOVA CT, 100 REGENCY FOREST DRIVE , SUITE 160, CARY, NC, 27518, US

(73) Assignee: CONCERT TECHNOLOGY CORPORATION, Durham, NC (US)

(21) Appl. No.: 11/959,770

(22) Filed: Dec. 19, 2007

(51) Int. Cl. G06F 15/167; G06F 15/16

(52) U.S. Cl. 709/215; 709/219; 709/249

(57) ABSTRACT

A system and method are provided for place-shifting media items. In general, a media zone broker operates to enable place-shifting of media items shared with the media zone by associated users among user devices of the associated users in such a manner that each media item is played by at most a number (N) of the user devices at any one time. The number (N) is a function of collective rights to the media item of one or more of the users sharing the media item in the media zone. In one embodiment, the number (N) is the number of users sharing the media item in the media zone or a function of the number of users sharing the media item in the media zone.

### FIELD OF THE INVENTION

The present invention relates to place-shifting media items among users in a social network.

### BACKGROUND OF THE INVENTION

In today's digital world, there is an enormous amount of media content such as songs and videos available to users. As such, users are always looking for new ways to explore and experience new media content. One technique for exploring and experiencing new media content is for users to share their own media content with other users. However, sharing media content among users has traditionally resulted in many legal issues. As such, there is a need for a system and method enabling users to share their media content with other users in a legal manner.

### SUMMARY OF THE INVENTION

The present invention relates to place-shifting media items among user devices of a group of users. In one embodiment, a number of media items are shared in a media zone by users associated with the media zone. The media zone is maintained by a media zone broker. The media zone broker operates to enable place-shifting of the media items shared in the media zone among user devices of the associated users in such a manner that each media item is played by at most a number (N) of the user devices at any one time. The number (N) is a function of collective rights to the media item of one or more of the users sharing the media item in the media zone. In one embodiment, the number (N) is the number of users sharing the media item in the media zone or a function of the number of users sharing the media item in the media zone. More specifically, for each media item, the media zone broker maintains a master schedule identifying times at which the media item has been scheduled for place-shifting to, or playback by, user devices associated with the users of the media zone. Based on the master schedule, the media zone broker ensures that the corresponding media item is place-shifted to at most N user devices at any one time. To enforce scheduling, any desired licensing or Digital Rights Management (DRM) technique may be used.

Those skilled in the art will appreciate the scope of the present invention and realize additional aspects thereof after reading the following detailed description of the preferred embodiments in association with the accompanying drawing figures.

### BRIEF DESCRIPTION OF THE DRAWINGS FIGURES

The accompanying drawing figures incorporated in and forming a part of this specification illustrate several aspects of the invention, and together with the description serve to explain the principles of the invention.

FIG. 1 illustrates a system for place-shifting media items according to one embodiment of the present invention;

FIG. 2 is a flow chart providing an overview of the operation of the media broker of FIG. 1 according to one embodiment of the present invention;

FIG. 3 illustrates an exemplary master schedule of a media item maintained by the media broker of FIG. 1 according to one embodiment of the present invention;

FIG. 4 illustrates the operation of the system of FIG. 1 according to a first embodiment of the present invention;

FIG. 5 illustrates the operation of the system of FIG. 1 according to a second embodiment of the present invention;

FIG. 6 is a block diagram of the central server of FIG. 1 according to one embodiment of the present invention; and

FIG. 7 is a block diagram of one of the user devices of FIG. 1 according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

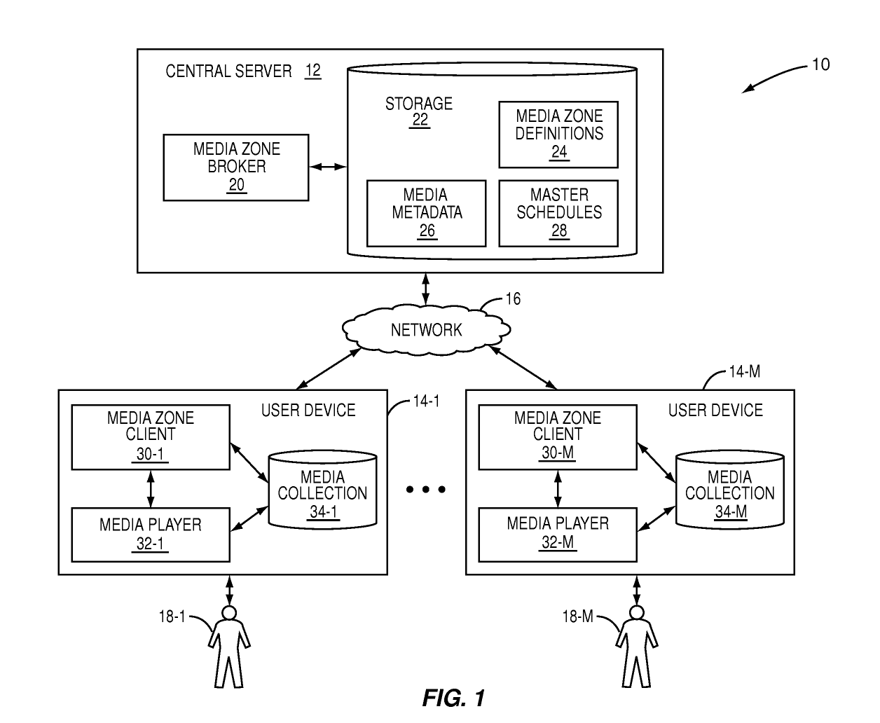

FIG. 1 illustrates a system 10 for place-shifting media items according to one embodiment of the present invention. In general, the system 10 includes a central server 12 and a number of user devices 14-1 through 14-M connected via a network 16. The network 16 may be any type of Wide Area Network (WAN) or Local Area Network (LAN), or any combination thereof. In addition, the network 16 may include wired components, wireless components, or both wired and wireless components. Users 18-1 through 18-M are associated with the user devices 14-1 through 14-M. Note that while a single central server 12 is illustrated in FIG. 1, the present invention is not limited thereto. The functionality of the central server 12 may alternatively be distributed among multiple servers.

The central server 12 includes a media zone broker 20 and storage 22. The media zone broker 20 is preferably implemented in software but may alternatively be implemented in hardware or a combination of hardware and software. In general, the media zone broker 20 operates to maintain one or more media zones. A media zone is a collection of media items shared by one or more of the users 18-1 through 18-M registered with or otherwise associated with the media zone. The media zones may be user-defined or system-defined. Further, a media zone may be a user-based media zone, a content-based media zone, or a combined user-based and content-based media zone. As used herein, a user-based media zone includes a catalog of media items shared by one or more specified users. A content-based media zone includes a catalog of shared media items satisfying one or more content-based criteria. A combined user-based and content-based media zone includes a catalog of shared media items satisfying one or more user-based criteria and one or more content-based criteria.

In addition, as discussed below in detail, the media zone broker 20 operates to enable place-shifting of media items in a media zone among a group of users associated with the media zone. The users associated with the media zone are users from the users 18-1 through 18-M that share media items in the media zone. In addition, the users associated with the media zone may be guests, which are other users from the users 18-1 through 18-M that do not share any media items in the media zone. The users associated with the media zone form a social network. The media items may generally be any type of digital content. For example, the media items may be audio media items such as, but not limited to, songs or audio books; video media items such as, but not limited to, movies or television programs; video games; or the like. As used herein, place-shifting is the sharing of a particular media item among a group of users in such a manner that playback rights are only given to up to N users in the group at any one time. The number (N) is a function of collective rights of the group of users to the particular media item. Note that it is assumed that a user sharing a media item with the group has the right to share the media item in the manner discussed herein. In one embodiment, N is a number of users in the group that are sharing the media item with the group. In another embodiment, each user sharing the particular media item may have the right to place-shift the media item to more than one other user. The users sharing the media item with the group are users that own or have otherwise acquired rights to play the media item. However, as discussed below, the present invention is not limited thereto. In effect, the playback rights of the users owning or having otherwise acquired rights to the media item are shared with the other users in the group.

The storage 22 may be a database or any similar collection of information stored on one or more digital storage devices such as, for example, one or more hard disk drives or the like. The storage 22 includes media zone definitions 24, media metadata 26, and master schedules 28. The media zone definitions 24 include a media zone definition for each of the media zones maintained by the media zone broker 20. A media zone definition includes one or more criteria defining the media zone. As discussed below, media items shared by the users 18-1 through 18-M that satisfy the criteria are added to the media zone. For a user-based media zone, the criteria defining the media zone includes information identifying one or more users from the users 18-1 through 18-M whose shared media items are to be included in the media zone. The information identifying the one or more users is also referred to herein as user-based criteria. The information identifying the users may be, for example, user identifiers (IDs), names, or the like. Alternatively, the information identifying the users may include demographic information, biographical information, user preferences, location provided by, for example, a Global Positioning System (GPS) receiver or a Location Based Service (LBS), or the like, which may be compared to user profiles of the users 18-1 through 18-M in order to identify users for the media zone. Media items shared by users satisfying the user-based criteria are added to the media zone.

For a content-based media zone, the criteria defining the media zone is content-based criteria. The content-based criteria may vary depending on the type of media item to be included in the media zone. For example, for music, the content-based criteria may be one or more specified music genres, one or more specified music artists, one or more specified time periods, characteristics such as bit-rate or rhythm, or the like. As another example, for videos, the content-based criteria may be one or more specified video categories, one or more specified actors or other participants appearing in the video, one or more keywords or phrases associated with the videos by the creator of the video, or the like. Shared media items satisfying the content-based criteria are added to the media zone. Note that for a combined user-based and content-based media zone, the criteria defining the media zone includes both user-based and content-based criteria.

The criteria defining the media zone may include additional criteria such as, for example, time-based criteria. For example, a media zone may only exist or be available at certain times of the day, certain days of the week, certain months, a certain date or range of dates, or the like. As another example, the user-based criteria and/or the content-based criteria for the media zone may vary depending on time of day, day of the week, month of the year, date, or the like.

The media zone definition of the media zone also includes a catalog or list of shared media items in the media zone. In general, media items satisfying the criteria defining the media zone are added to the catalog of media items for the media zone. More specifically, for a user-based media zone, the catalog includes media items shared by the one or more of the users 18-1 through 18-M satisfying the user-based criteria defining the media zone. For a content-based media zone, the catalog includes media items shared by any of the users 18-1 through 18-M that satisfy the content-based criteria defining the media zone. For a combined user-based and content-based media zone, the catalog includes media items shared by one or more of the users 18-1 through 18-M satisfying the user-based criteria for the media zone and satisfying the content-based criteria for the media zone.

For each media item in the catalog of media items, the media zone definition for the media zone may also include information identifying each user of the users 18-1 through 18-M that is sharing the media item with the media zone. Thus, if the users 18-1 and 18-M are sharing a particular media item in the media zone, the media zone definition may include information identifying the users 18-1 and 18-M as the sharing users for that media item. Lastly, the media zone definition may include other information such as, for example, constraints on a minimum or maximum amount of content in the media zone, a minimum or maximum number of users or media zone clients to be associated with the media zone, constraints on time or play length, constraints on file size, or the like.

The media metadata 26 includes metadata describing each media item in the one or more media zones maintained by the media zone broker 20. The metadata may vary depending on the type of media item. For example, for a song, the metadata may include a title of the song, a genre of the song, an artist of the song, an album on which the song was released, a date of release of the song, or the like. For a video, the metadata may include a title of the video, a genre of the video, names of actors or participants appearing in the video, a date of release or creation of the video, or the like.

The master schedules 28 include a master schedule for each media item shared in the one or more media zones maintained by the media zone broker 20. For each media item, the corresponding master schedule includes times at which playback of the media item is scheduled to occur at a user device of a requesting user. In general, the master schedules 28 are used by the media zone broker 20 to determine the availability of the media items in response to requests for the media items received from the users devices 14-1 through 14-M.

In addition, for each media item shared by the users 18-1 through 18-M, the master schedule includes information identifying the number (N) of user devices to which the media item may be place-shifted at any one time. This information may alternatively be maintained separate from the master schedule. In one embodiment, each sharing user results in a right to place-shift the media item to one of the user devices 18-1 through 18-M at any one time. Thus, if there is one user sharing a media item, the media item may be place-shifted to only one of the user devices 14-1 through 14-M at any one time. Thus, in other words, only one user is allowed to play the media item at any one time. In contrast, if there are two users sharing a media item, the media item may be place-shifted to two user devices at any one time. Thus, in other words, two users are allowed to play the media item at any one time. In addition or alternatively, the media zone broker 20 may obtain the right to place-shift media items shared in the media zone from an external source. The external source may be, for example, a media distribution service such as or similar to Apple's iTunes® store.

Note that if a media item is shared in more than one media zone, the rights to place-shift the media item must, in one embodiment, be shared by the users of the media zones. In another embodiment, each of the media zones may have separate rights for place-shifting the media item.

The user devices 14-1 through 14-M may each be, for example, a personal computer, a mobile device capable of connecting to the network 16, a set-top box capable of connecting to the network 16, a gaming console having media playback capabilities and capable of connecting to the network 16, or the like. The user devices 14-1 through 14-M include media zone clients 30-1 through 30-M, media players 32-1 through 32-M, and user media collections 34-1 through 34-M (hereinafter media collections 34-1 through 34-M), respectively.

Using the user device 14-1 as an example, the media zone client 30-1 and the media player 32-1 may each be implemented in software, hardware, or a combination thereof. In addition, while the media zone client 30-1 and the media player 32-1 are illustrated separately, the media zone client 30-1 and the media player 32-1 may alternatively be combined into a single software and/or hardware application. In general, the media zone client 30-1 operates to share media items from the media collection 34-1 in one or more of the media zones maintained by the media zone broker 20, request media items shared in a media zone, and effect playback of the requested media items at times scheduled by the media zone broker 20. The media player 32-1 operates to perform playback of media items from the media collection 34-1 or media items requested and obtained by the media zone client 30-1. The media collection 34-1 includes a number of media items owned or otherwise acquired by the user 18-1. For example, the user 18-1 may have purchased the media items from an online media distribution service such as Apple's iTunes® store, obtained the media items from a Compact Disc (CD) or similar storage medium, or the like.

Note that some functions or features of the user devices 14-1 through 14-M may be moved to some mediating device. For example, the user device 14-1 may be a portable device, and the media collection 34-1 may be stored remotely on another device belonging to the user 18-1 such as a personal computer. Media items from the media collection 34-1 that are shared with the media zone may thereafter be obtained from the personal computer rather than the user device 14-1. Note that the media zone broker 20 may maintain information indicating that the media collection 34-1 is stored at the personal computer rather than the user device 14-1 such that requests for those media items can be directed to the personal computer.

It should also be noted that in addition to the user devices 14-1 through 14-M, the system 10 may include one or more additional devices that are not associated with individual users but are rather associated with a business or the like. For example, a coffee shop or music store may include a server or some similar device hosting a media zone client. The server may then join a media zone on behalf of the business and share media items with the media zone in a manner similar to that of the user devices 14-1 through 14-M.

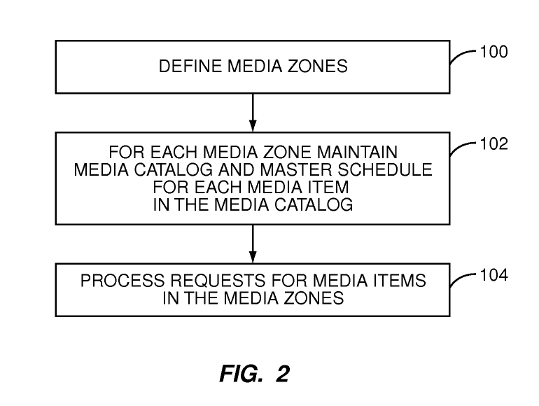

FIG. 2 is a flow chart providing an overview of the operation of the media zone broker 20 of FIG. 1 according to one embodiment of the present invention. First, a number of media zones are defined (step 100). The media zones may be user-defined or system-defined. Then, for each media zone, the media zone broker 20 maintains a catalog of media items shared in the media zone and a master schedule for each of the media items (step 102). More specifically, using the criteria defining a media zone, the media zone broker 20 identifies media items shared by the users 18-1 through 18-M that satisfy the criteria of the media zone. Those media items are added to the catalog of media items for the media zone. The media zone broker 20 preferably updates the catalog of media items as the user devices 14-1 through 14-M become unavailable and as new user devices become available.

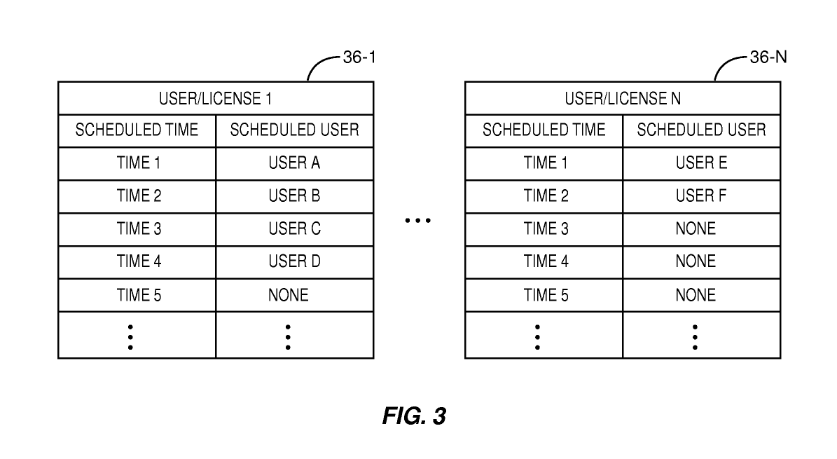

The media zone broker 20 also maintains the master schedule for each media item shared in a media zone. Referring briefly to FIG. 3, an exemplary master schedule for a media item is illustrated. In this example, the master schedule includes a number of sub-schedules 36-1 through 36-N, where each of the sub-schedules 36-1 through 36-N corresponds to one of a number of users sharing the media item or one of a number of licenses for the media item otherwise granted to the media zone broker 20. The sub-schedules 36-1 through 36-N identify times at which the media item is scheduled for playback at the user devices of requesting users. By maintaining the sub-schedules 36-1 through 36-N, the media zone broker 20 ensures that the media item is place-shifted to only N user devices at any given time. For example, if the media item is shared by the user 18-1, the media zone broker 20 maintains the master schedule such that the media item is place-shifted to only one of the user devices 14-1 through 14-M at any given time. If the media item is shared by both the user 18-1 and the user 18-M, the media zone broker 20 maintains the sub-schedules 36-1 and 36-2 for the media item such that the media item is place-shifted to only two of the user devices 14-1 through 14-M at any given time.

As an alternative, rather than scheduling times at which the media item is scheduled for playback at the user devices of requesting users, the master schedule may generally indicate the order in which the media item is to be place-shifted to the user devices of requesting users. A token model may then be used such that the rights to play the media item are passed from one user device to another in the order indicated by the master schedule. As another alternative, the master schedule may include softer time periods such as, for example, in the morning, afternoon, evening, or night.

Returning to FIG. 2, the media zone broker 20 also processes requests for media items shared in the one or more media zones maintained by the media zone broker 20 (step 104). As discussed below, upon receiving a request for a media item shared in a media zone, the media zone broker 20 determines the availability of the requested media item by examining the master schedule for the media item and schedules a time for playback of the media item at the requesting user device. The media zone broker 20 then provides availability information to the requesting user device identifying the scheduled time for playback of the media item at the requesting user device.

When scheduling media items for place-shifting, the media zone broker 20 may use any type of scheduling technique. In one embodiment, requesting users are assigned priorities. The priorities are then used for scheduling. Note that even if a user has been scheduled for a media item, that user may be displaced by another user having a higher priority. As a first example, the media zone broker 20 may use a tit-for-tat scheduling technique where a priority assigned to a requesting user for scheduling is a function of an amount of content the requesting user has shared or has actually place-shifted to another user. As a second example, the media zone broker 20 may use a content value scheduling technique where a priority assigned to a requesting user for scheduling is a function of a value of the content the requesting user has shared. The value may be determined as a function of the number of other users that have also shared the same content. As a third example, the media zone broker 20 may use a scheduling technique where a priority assigned to a requesting user for scheduling is a function of an actual amount of content place-shifted to other users. As a fourth example, the media zone broker 20 may assign priority to a requesting user as a function of whether the requesting user has paid a fee for the place-shifting service. Lastly, the media zone broker 20 may assign a highest priority to a requesting user that is also a sharing user for the requested media item.

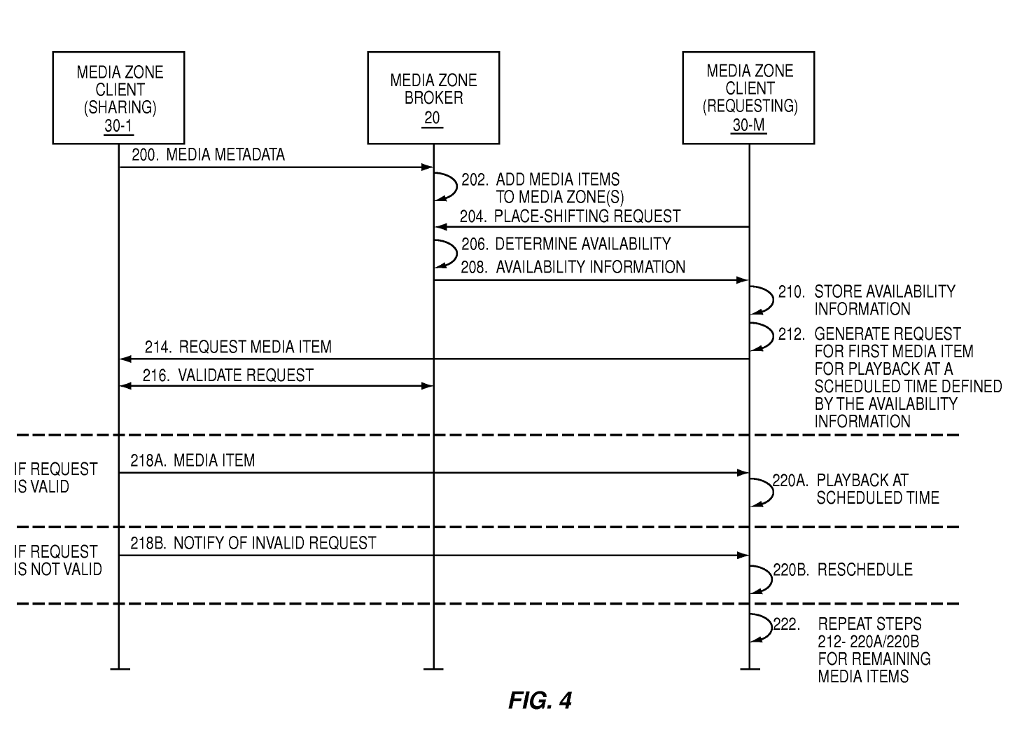

FIG. 4 illustrates the operation of the system 10 of FIG. 1 according to a first embodiment of the present invention. First, the media zone client 30-1, which for this example is also referred to as the sharing media zone client 30-1, provides metadata for a number of media items to be shared in a media zone to the media zone broker 20 (step 200). Note that if the media zone broker 20 already has or has access to the metadata for the media items, the sharing media zone client 30-1 may provide globally unique media item IDs for the media items or any other type of information identifying the media items.

More specifically, in one embodiment, the user 18-1 selects one or more media items to share in a particular media zone maintained by the media zone broker 20. The user 18-1 may manually locate the media zone in which he or she desires to share media content. Alternatively, the media zone may be automatically selected for the user 18-1, or recommended to the user 18-1, based on an analysis of the media collection 34-1 of the user 18-1 as compared to the criteria defining the media zones maintained by the media zone broker 20, based on a user profile of the user 18-1 as compared to the criteria defining the media zones maintained by the media zone broker 20, or the like. Once the desired media zone is located, the metadata for all media items that the user 18-1 has given permission to share, or information identifying all media items that the user 18-1 has given permission to share, is provided to the media zone broker 20. Alternatively, the sharing media zone client 30-1 may analyze the media collection of the user 18-1 or a select subset thereof in order to identify media items that satisfy the criteria of the media zone. The metadata of the identified media items, or information identifying the identified media items, is then provided to the media zone broker 20.

In an alternative embodiment, rather than identifying a media zone for the user 18-1, the user 18-1 may choose to share the entire media collection 34-1 or a select subset thereof. The metadata of the media items to be shared, or information identifying the media items to be shared, may then be provided to the media zone broker 20. The media zone broker 20 may then compare the metadata describing the media items to the criteria defining the media zones maintained by the media zone broker 20 in order to allocate each of the media items to the appropriate media zone.

The media items shared by the sharing media zone client 30-1 are then added to the catalog(s) of the appropriate media zone(s) (step 202). If one or more of the shared media items are already included in the catalog for the media zone in which they are to be shared, the corresponding media zone definition may be updated to add the user 18-1 as a sharing user for those media items and to update the number of licenses available for those media items.

At some time thereafter, the media zone broker 20 receives a request for one or more media items shared in a media zone from a requesting media zone client, which in this example is the media zone client 30-M (step 204). More specifically, in one embodiment, the request is a request for a playlist of all of the media items in a media zone, a request for a playlist of a desired number of the media items in a media zone, or a request for a predefined playlist of media items in one or more media zones. The predefined playlists may be predefined by the users 18-1 through 18-M or predefined by the media zone broker 20. In another embodiment, the request is for one or more media items selected by the requesting user 18-M associated with the requesting media zone client 30-M. Note that while in this example the one or more requested media items are shared in the same media zone, the one or more requested media items may alternatively be shared in two or more different media zones.

In response to the request, the media zone broker 20 determines the availability of the requested media items by examining the master schedules for the one or more requested media items (step 206). The media zone broker 20 then sends availability information identifying a scheduled time for each of the requested media items to the requesting media zone client 30-M (step 208). In one embodiment, the availability information includes a place-shifting license, or other digital rights mechanism, for each of the requested media items. Preferably, each place-shifting license permits a single playback of the corresponding media item at a scheduled time.

More specifically, in a first embodiment, the request is a request for a playlist of all of the media items in a media zone where the media zone broker 20 creates the requested playlist or a request for a playlist of a desired number of the media items in a media zone where the media zone broker 20 creates the requested playlist. The media zone broker 20 examines the master schedules of the media items shared in the media zone to determine when the media items are available for place-shifting to, or playback at, the user device 14-M of the requesting media zone client 30-M. The media zone broker 20 then creates the requested playlist based on the availability of the media items shared in the media zone and schedules the media items in the requested playlist for place-shifting to the user device 14-M of the requesting media zone client 30-M accordingly. The media zone broker 20 may coordinate the scheduling of the media items in the requested playlist such that there is no substantial gap in time between playback of the media items in the playlist at the user device 14-M.

The requested playlist may alternatively be a predefined playlist of media items shared in the media zone created by the media zone broker 20 or a user associated with the media zone. The media zone broker 20 examines the master schedules of the media items in the requested playlist to determine when the media items are available for place-shifting to, or playback at, the user device 14-M of the requesting media zone client 30-M. The media zone broker 20 schedules the media items in the requested playlist for place-shifting to the user device 14-M of the requesting media zone client 30-M at select times at which the media items are available. The media zone broker 20 may coordinate the scheduling of the media items in the requested playlist such that the media items in the playlist remain in a defined order. Alternatively, the order of the media items in the playlist may be rearranged in order to accommodate scheduling. In addition, the media zone broker 20 may coordinate the scheduling of the media items such that there is no substantial gap in time between playback of the media items in the playlist at the user device 14-M.

The request for the playlist may additionally include a desired time to begin playback of the requested playlist. If so, the media zone broker 20 may schedule the media items in the playlist in such a manner as to permit the playlist to begin playback at the user device 14-M of the requesting media zone client 30-M at the desired time. If this is not possible, the media zone broker 20 may selected the closest available time to the desired time or provide the requesting media zone client 30-M with a list of one or more times at which playback of the requested playlist at the user device 14-M may alternatively begin. The requesting media zone client 30-M may automatically select, or the requesting user 18-M may manually select, one of the alternative times. The selected time may then be returned to the media zone broker 20, which then proceeds to schedule the media items in the requested playlist for place-shifting to the user device 14-M of the requesting media zone client 30-M.

In a second embodiment, the request is for one or more media items selected by the requesting user 18-M associated with the requesting media zone client 30-M. As such, for each requested media item, the media zone broker 20 may examine the corresponding master schedule to identify an earliest time at which the requested media item may be place-shifted to the requesting user device 14-M. The master schedule for the requested media item is then updated to schedule place-shifting of the media item at the requesting user device 14-M at the identified time. Note that if multiple media items are requested, the media zone broker 20 may coordinate scheduling for the requested media items. For example, if two media items are requested, the media zone broker 20 coordinates scheduling for the two media items to ensure that the scheduled time for one of the requested media items does not overlap the scheduled time for the other requested media item.

Rather than selecting the earliest available time for the requested media items, the media zone broker 20 may alternatively provide a list of one or more available times for each of the requested media items to the requesting media zone client 30-M. The user 18-M may then select, or the requesting media zone client 30-M may automatically select, one of the available times for each of the requested media items.

The request for the one or more media items selected by the requesting user 18-M may additionally include a preferred time for playback of each of the media items. In this embodiment, the media zone broker 20 may attempt to schedule the requested media items for place-shifting to the requesting user device 14-M at the preferred times. However, if a media item is unable to be scheduled at the preferred time, the media zone broker 20 may notify the requesting media zone client 30-M that the media item is unavailable at the preferred time and optionally provide one or more alternative times at which the media item is available.

Once place-shifting of the requested media items has been scheduled and the availability information has been returned to the requesting media zone client 30-M, the requesting media zone client 30-M stores the availability information (step 210). The requesting media zone client 30-M then generates a request for a first media item of the requested media items for playback at the scheduled time (step 212). Note that the first media item may be the only requested media item or one of a number of requested media items. In one embodiment, the request includes a media item ID of the first media item and the place-shifting license issued to the requesting media zone client 30-M for the first media item. The requesting media zone client 30-M then sends the request to the sharing media zone client of the user device of the user sharing the media item, which in this example is the sharing media zone client 30-1 (step 214). The request is generated and sent at a time sufficiently before the scheduled time for playback to allow for playback of the first requested media item at the scheduled time. In one embodiment, the request is a request to stream the first requested media item to the user device 14-M of the requesting media zone client 30-M for playback by the media player 32-M. In another embodiment, the request is a request to download the first requested media item.

In response to the request, the sharing media zone client 30-1 interacts with the media zone broker 20 to validate the request (step 216). The request may be invalid if, for example, the time originally scheduled for the requesting user 18-M was subsequently assigned to a higher priority user. In one embodiment, in order to validate the request, the sharing media zone client 30-1 sends the media item ID and the place-shifting license to the media zone broker 20 for validation. The media zone broker 20 may then validate the request by checking the master schedule for the media item to ensure that the media item is still scheduled for place-shifting to the requesting user device 14-M at the scheduled time or by determining whether the place-shifting license granted to the requesting media zone client 30-M has been revoked.

In an alternative embodiment, the requesting media zone client 30-M may validate the request with the media zone broker 20 prior to sending the request to the sharing media zone client 30-1. As another alternative, the media zone broker 20 may not issue a place-shifting license to the requesting media zone client 30-M in step 208. Instead, the requesting media zone client 30-M may request a place-shifting license for the media item from the media zone broker 20 prior to making the request to the sharing media zone client 30-1 for the media item. The media zone client 20 may or may not issue the place-shifting license to the requesting media zone client 30-M depending on the validity of the request.

If the request is valid, the sharing media zone client 30-1 provides the requested media item to the requesting media zone client 30-M (step 218A). In one embodiment, the sharing media zone client 30-1 streams the requested media item to the requesting media zone client 30-M at the scheduled time. In another embodiment, the sharing media zone client 30-1 downloads the requested media item to the requesting media zone client 30-M for storage at the requesting user device 14-M. The requested media item may be partially or completely downloaded prior to the scheduled time for playback. Note that while only one sharing media zone client 30-1 is utilized in this example, multiple sharing media zone clients may alternatively be used to efficiently transfer the media item to the requesting user device 14-M.

The requesting media zone client 30-M then effects playback of the requested media item by the media player 32-M at the scheduled time (step 220A). The requesting media zone client 30-M may effect playback by providing the requested media item to the media player 32-M for playback at the scheduled time, notifying the media player 32-M of the availability of the requested media item, or the like. In addition, the requesting media zone client 30-M may perform Digital Rights Management (DRM) functions. For example, the requested media item may be encrypted. As such, the requesting media zone client 30-M may decrypt the requested media item using a decryption key provided to the requesting media zone client 30-M using any desired key management technique.

In one embodiment, the scheduled time for playback is preferably a time window defined by a starting time and a playback time, or duration, of the media item. Alternatively, the time window may be defined by a starting time and an ending time. The scheduled time may include additional time to permit pausing or rewinding of the requested media item. The scheduled time may also include additional time beyond that required for playback of the media item to account for interruptions in playback. This may be particularly beneficial if the requested media item is provided in a streaming format. At the end of the scheduled time, playback of the requested media item is no longer permitted. Playback rights may be revoked by, for example, revoking the place-shifting license granted to the requesting media zone client 30-M for the media item.

Returning to step 216, if the request is invalid, the sharing media zone client 30-1 notifies the requesting media zone client 30-M (step 218B). In this example, in response to the notification of the invalid request, the requesting media zone client 30-M reschedules the first requested media item (step 220B). More specifically, the requesting media zone client 30-M sends a new request for the media item to the media zone broker 20. The media zone broker 20 determines the availability of the media item and schedules the media item for place-shifting to the requesting user device 14-M in the manner described above. At this point, the requesting media zone client 30-M repeats steps 212 through 220A/220B for the remaining requested media items (step 222). Note however that for each media item, the sharing media zone client may vary.

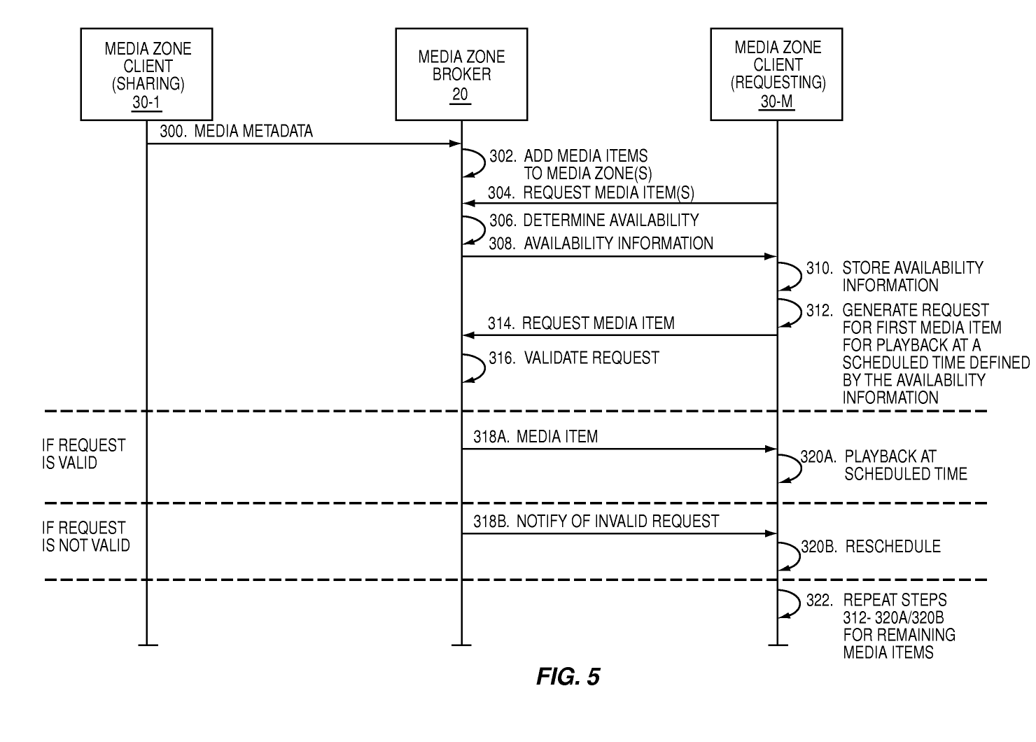

FIG. 5 illustrates the operation of the system 10 of FIG. 1 according to a second embodiment of the present invention. In this embodiment, the media zone broker 20 hosts, or otherwise has access to, the media items shared in the one or more media zones, and the requesting media zone client 30-M obtains the requested media items from the media zone broker 20, rather than the sharing media zone client 30-1, at the scheduled times.

First, the sharing media zone client 30-1 provides metadata for a number of media items to be shared in a media zone to the media zone broker 20 (step 300). Note that if the media zone broker 20 already has or has access to the metadata for the media items, the sharing media zone client 30-1 may provide globally unique media item IDs for the media items or any other type of information identifying the media items.

More specifically, in one embodiment, the user 18-1 selects one or more media items to share in a particular media zone maintained by the media zone broker 20. The user 18-1 may manually locate the media zone in which he or she desires to share media content. Alternatively, the media zone may be automatically selected for the user 18-1, or recommended to the user 18-1, based on an analysis of the media collection 34-1 of the user 18-1 as compared to the criteria defining the media zones maintained by the media zone broker 20, based on a user profile of the user 18-1 as compared to the criteria defining the media zones maintained by the media zone broker 20, or the like. Once the desired media zone is located, the metadata for all media items that the user 18-1 has given permission to share, or information identifying all media items that the user 18-1 has given permission to share, is provided to the media zone broker 20. Alternatively, the sharing media zone client 30-1 may analyze the media collection of the user 18-1 or a select subset thereof in order to identify media items that satisfy the criteria of the media zone. The metadata of the identified media items, or information identifying the identified media items, is then provided to the media zone broker 20.

In an alternative embodiment, rather than identifying a media zone for the user 18-1, the user 18-1 may choose to share the entire media collection 34-1 or a select subset thereof. The metadata of the media items to be shared, or information identifying the media items to be shared, may then be provided to the media zone broker 20. The media zone broker 20 may then compare the metadata describing the media items to the criteria defining the media zones maintained by the media zone broker 20 in order to allocate each of the media items to the appropriate media zone.

The media items shared by the sharing media zone client 30-1 are then added to the catalog(s) of the appropriate media zone(s) (step 302). In one embodiment, the media zone broker 20 obtains the shared media items from the sharing media zone client 30-1 and then stores the shared media items at the central server 12. Note that any of the media items that are already stored at the central server 12 would not need to be obtained from the sharing media zone client 30-1. The media zone broker 20 may alternatively obtain the shared media items from the sharing media zone client 30-1 as needed. Once obtained, the shared media items may be permanently stored or cached for later use. In another embodiment, the media zone broker 20 is associated with or has access to a media distribution service such as or similar to, for example, Apple's iTunes® store. In this case, the media zone broker 20 may not need to obtain the shared media items from the sharing media zone client 30-1. However, place-shifting is still controlled based on the collective rights of the sharing users. Regardless of how the shared media items are obtained by the media zone broker 20, for each shared media item, the media zone definition of the corresponding media zone is updated such that the shared media item is included in the catalog of media items for the media zone, the user 18-1 is listed as a sharing user for the media item, and the number of user devices to which the media item may be place-shifted at any one time is increased by one.

At some time thereafter, the media zone broker 20 receives a request for one or more media items shared in a media zone from a requesting media zone client, which in this example is the media zone client 30-M (step 304). Note that while in this example the request is for one or more media items in one media zone, the request may alternatively be for media items shared in two or more media zones. In response to the request, the media zone broker 20 determines the availability of the requested media items by examining the master schedules for the one or more requested media items (step 306). The media zone broker 20 then sends availability information identifying a scheduled time for each of the requested media items to the requesting media zone client 30-M (step 308). In one embodiment, the availability information includes a place-shifting license for each of the requested media items. Each place-shifting license permits playback of the corresponding media item at a scheduled time.

Once place-shifting of the requested media items has been scheduled and the availability information has been provided to the requesting media zone client 30-M, the requesting media zone client 30-M stores the availability information (step 310). The requesting media zone client 30-M then generates a request for a first media item of the requested media items for playback at the scheduled time (step 312). Note that the first media item may be the only requested media item or one of a number of requested media items. In one embodiment, the request includes a media item ID of the first media item and the place-shifting license issued to the requesting media zone client 30-M for the first requested media item. The requesting media zone client 30-M then sends the request to the media zone broker 20 (step 314). The request is generated and sent at a time sufficiently before the scheduled time for playback to allow for playback of the first media item at the scheduled time. In one embodiment, the request is a request to stream the first requested media item to the user device 14-M of the requesting media zone client 30-M for playback by the media player 32-M. In another embodiment, the request is a request to download the first requested media item.

In response to the request, the media zone broker 20 validates the request (step 316). In one embodiment, the request includes the media item ID and the place-shifting license granted to the requesting media zone client 30-M for place-shifting the media item to the requesting user device 14-M at the scheduled time. The media zone broker 20 may then validate the request by checking the master schedule for the media item to ensure that the media item is still scheduled for place-shifting to the requesting user device 14-M at the previously scheduled time or by determining whether the place-shifting license granted to the requesting media zone client 30-M has been revoked.

If the request is valid, the media zone broker 20 provides the requested media item to the requesting media zone client 30-M (step 318A). In one embodiment, the media zone broker 20 streams the requested media item to the requesting media zone client 30-M at the scheduled time. In another embodiment, the media zone broker 20 downloads the requested media item to the requesting media zone client 30-M for storage at the user device 14-M. The requested media item may be partially or completely downloaded prior to the scheduled time for playback. The requesting media zone client 30-M then effects playback of the requested media item by the media player 32-M at the scheduled time (step 320A).

Returning to step 316, if the request is invalid, the media zone broker 20 notifies the requesting media zone client 30-M (step 318B). In this example, in response to the notification of the invalid request, the requesting media zone client 30-M reschedules the first requested media item (step 320B). More specifically, the requesting media zone client 30-M sends a new request for the media item to the media zone broker 20. The media zone broker 20 determines the availability of the media item and schedules the media item for place-shifting to the requesting user device 14-M in the manner described above. Alternatively, the media zone broker 20 may automatically reschedule the request upon determining that the request is invalid. At this point, the requesting media zone client 30-M repeats steps 312 through 320A/320B for the remaining requested media items (step 322).

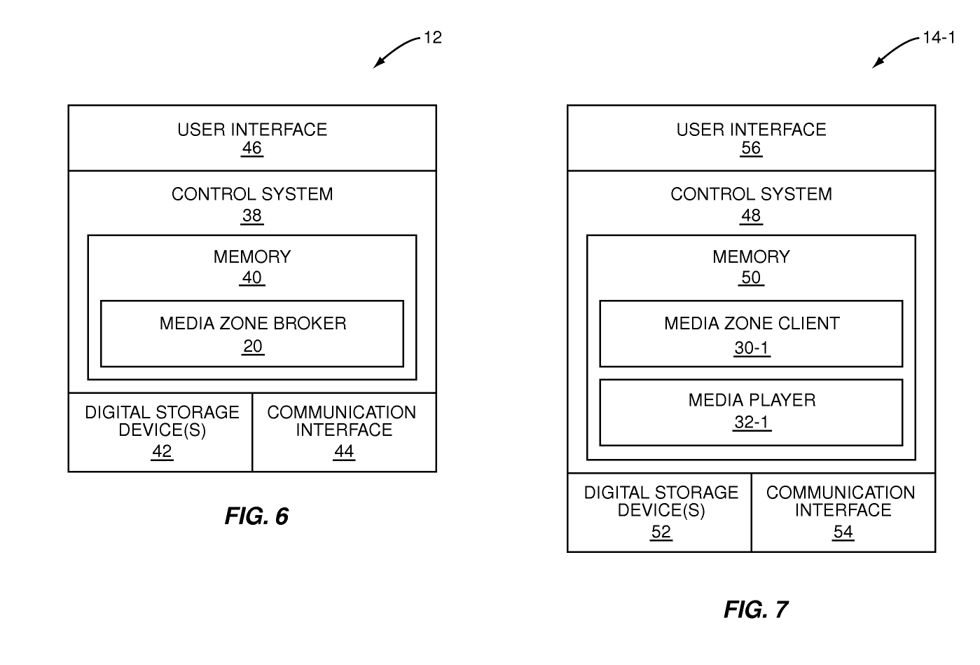

FIG. 6 is a block diagram of an exemplary embodiment of the central server 12 of FIG. 1. In general, the central server 12 includes a control system 38 having associated memory 40. In this embodiment, the media zone broker 20 is implemented in software and stored in memory 40. However, the present invention is not limited thereto. The central server 12 also includes one or more digital storage devices 42 such as, for example, one or more hard disk drives or the like. The media zone definitions 24 (FIG. 1), the media metadata 26 (FIG. 1), and the master schedules 28 (FIG. 1) may be stored by the one or more digital storage devices 42. Alternatively, the media zone definitions 24, the media metadata 26, and the master schedules 28 may be stored by a remote database. The central server 12 also includes a communication interface 44 communicatively coupling the central server 12 to the network 16 (FIG. 1). Lastly, the central server 12 includes a user interface 46, which may include components such as, for example, a display, one or more user input devices, and the like.

FIG. 7 is a block diagram of an exemplary embodiment of the user device 14-1 of FIG. 1. This discussion is equally applicable to the other user devices 14-2 through 14-M. In general, the user device 14-1 includes a control system 48 having associated memory 50. In this embodiment, the media zone client 30-1 and the media player 32-1 are implemented in software and stored in the memory 50. However, the present invention is not limited thereto. The user device 14-1 also includes one or more digital storage devices 52 such as, for example, one or more hard disk drives or the like. The media collection 34-1 (FIG. 1) may be stored by the one or more digital storage devices 52. The user device 14-1 also includes a communication interface 54 communicatively coupling the user device 14-1 to the network 16 (FIG. 1). Lastly, the user device 14-1 includes a user interface 56, which may include components such as, for example, a display, one or more user input devices, a speaker, and the like.

The present invention provides substantial opportunity for variation without departing from the spirit or scope of the present invention. As a first example, while the discussion above focuses on a one-to-one correspondence between the number of users sharing a media item and the number of user devices to which the media item may be place-shifted at any one time, the present invention is not limited thereto. More liberal usage rights may be granted. For instance, the rights given to one of the sharing users may permit the sharing user to place-shift the media item to any number of other users at any one time. As a second example, the media zone broker 20 may track the usage of the shared media items such that corresponding payments may be made to the sharing users, the content creators, or the like. As a third example, the users associated with a media zone may be viewed as a social network. As such, additional social network features such as chatting or the like may be provided between the users associated with a media zone. As a final example, the functionality of the media zone broker 20 may be implemented on one of the user devices 14-1 through 14-M or distributed among two or more of the user devices 14-1 through 14-M. For instance, the media zone broker 20 may be implemented on the user devices 14-1 through 14-M in a peer-to-peer (P2P) architecture.

Those skilled in the art will recognize improvements and modifications to the preferred embodiments of the present invention. All such improvements and modifications are considered within the scope of the concepts disclosed herein and the claims that follow.

What is claimed is:

1. A method comprising:
providing a group comprising a plurality of users associated with a plurality of user devices, wherein a plurality of media items are shared with the group by at least one of the plurality of users; and
enabling place-shifting of the plurality of media items among the plurality of user devices associated with the plurality of users in such a manner that a media item of the plurality of media items is played by at most a number (N) of user devices from the plurality of user devices at any one time, the number (N) being a function of collective rights of the plurality of users to the media item.

2. The method of claim 1 wherein the number (N) is a function of a number of users from the plurality of users that are sharing the media item with the group.

3. The method of claim 1 wherein the number (N) is equal to a number of users from the plurality of users that are sharing the media item with the group.

4. The method of claim 1 wherein the number (N) is a function of a number of users from the plurality of users that are sharing the media item with the group and at least one additional right to the media item granted to the group by an external source.

5. The method of claim 1 wherein the number (N) is equal to a number of users from the plurality of users that are sharing the media item with the group plus at least one additional license for the media item granted to the group from an external source.

6. The method of claim 1 wherein the number (N) for the media item is independent from the number (N) for each other media item from the plurality of media items.

7. The method of claim 1 wherein enabling place-shifting of the plurality of media items comprises, for each media item of the plurality of media items, maintaining a master schedule in which each time at which the media item is scheduled for playback by one of the plurality of user devices is recorded.

8. The method of claim 7 wherein enabling place-shifting of the plurality of media items further comprises:
receiving a request for at least one media item of the plurality of media items from a requesting user device of the plurality of user devices;
examining the master schedule for the at least one media item to determine an availability of the at least one media item for playback by the requesting user device;
scheduling the at least one media item for playback by the requesting user device based on the availability of the at least one media item; and
providing, to the requesting user device, availability information indicating a scheduled time for each of the at least one media item.

9. The method of claim 8 wherein the request is a request for a playlist comprising at least a subset of the plurality of media items.

10. The method of claim 9 wherein the playlist is a predefined playlist.

11. The method of claim 9 further comprising creating the playlist in response to the request.

12. The method of claim 8 wherein the request is a request for at least one media item selected from the plurality of media items by a requesting user of the plurality of users associated with the requesting user device.

13. The method of claim 8 wherein the availability information comprises, for each media item, a license permitting a single play of the media item at the scheduled time for the media item.

14. The method of claim 8 wherein, for each media item of the at least one media item requested, the requesting user device obtains the media item from a user device of the plurality of user devices associated with a sharing user of the plurality of users that is sharing the media item with the group.

15. The method of claim 8 further comprising, for each media item of the at least one media item requested:
receiving, from the requesting user device, a request to obtain the media item for playback at the scheduled time for the media item;
obtaining the media item from a source selected from a group consisting of: a user device of the plurality of user devices associated with a sharing user of the plurality of users who is sharing the media item with the group, a media distribution service, and local storage; and
providing the media item to the requesting user device for playback at the requesting user device at the scheduled time.

16. The method of claim 15 further comprising, for each media item of the at least one media item requested, validating the request to obtain the media item prior to providing the media item to the requesting user device.

17. The method of claim 15 wherein providing the media item to the requesting user device comprises streaming the media item to the requesting user device at the scheduled time for the media item.

18. The method of claim 15 wherein providing the media item to the requesting user device comprises downloading the media item to the requesting user device for playback at the scheduled time for the media item.

19. A system comprising:
a communication interface communicatively coupling the system to a plurality of user devices associated with a plurality of users via a network; and
a control system associated with the communication interface and adapted to:
form a group comprising the plurality of users, wherein a plurality of media items are shared with the group by at least one of the plurality of users; and
enable place-shifting of the plurality of media items among the plurality of user devices associated with the plurality of users in such a manner that a media item of the plurality of media items is played by at most a number (N) of user devices from the plurality of user devices at any one time, the number (N) being a function of collective rights of the plurality of users to the media item.

20. A method of operation of a user device comprising:
sending a request to a media broker for at least one media item of a plurality of media items, wherein the media broker enables place- shifting of the plurality of media items among a plurality of user devices including the user device associated with a plurality of users in such a manner that a media item of the plurality of media items is played by at most a number (N) of user devices from the plurality of user devices at any one time, the number (N) being a function of collective rights of the plurality of users to the media item; receiving availability information from the media broker identifying, for each media item of the at least one media item requested, a scheduled time at which the media item is scheduled for playback at the user device; and
for each media item of the at least one media item requested,
obtaining the media item; and
effecting playback of the media item at the scheduled time for the media item.

21. The method of claim 20 wherein the plurality of users form a group, and obtaining the media item comprises obtaining the media item from a sharing user device of the plurality of user devices associated with a sharing user of the plurality of user devices that is sharing the media item with the group.

22. The method of claim 20 wherein obtaining the media item comprises obtaining the media item from the media broker.

23. The user device of claim 20 wherein the plurality of users form a group, and the number (N) is a function of a number of users from the plurality of users that are sharing the media item with the group.

24. The user device of claim 20 wherein the plurality of users form a group, and the number (N) is equal to a number of users from the plurality of users that are sharing the media item with the group.

25. A user device comprising:
a communication interface communicatively coupling the user device to a network; and
a control system associated with the communication interface and adapted to:
send a request to a media broker for at least one media item of a plurality of media items, wherein the media broker enables place-shifting of the plurality of media items among a plurality of user devices including the user device associated with a plurality of users in such a manner that a media item of the plurality of media items is played by at most a number (N) of user devices from the plurality of user devices at any one time, the number (N) being a function of collective rights of the plurality of users to the media item;
receive availability information from the media broker identifying, for each media item of the at least one media item requested, a scheduled time at which the media item is scheduled for playback at the user device; and
for each media item of the at least one media item requested:
obtain the media item; and
effect playback of the media item at the scheduled time for the media item.
